(19) United States
(12) Patent Application Publication
(10) Pub. No.: US 2012/0056351 A1
(43) Pub. Date: Mar. 8, 2012

(54) METHOD FOR FORMING AN INTEGRAL FAUCET CORE ASSEMBLY

(76) Inventor: Weiqiang XU, (US)

(21) Appl. No.: 12/965,794

(22) Filed: Dec. 10, 2010

(30) Foreign Application Priority Data
Sep. 7, 2010 (CN) 201010285960.9

(51) Int. Cl. B29C 63/44

(52) U.S. Cl. 264/277

(57) ABSTRACT

A method for forming an integral faucet core assembly comprises steps as follows: In step 1, a die for one-time molding and cores relatively set on the die are prepared to one-time mold a body with two inlet channels, at least one outlet channel, and at least one middle fluid channel; the middle fluid channel is arranged perpendicular to the two inlet channels; exteriors of the channels are respectively provided with an inlet, an outlet, and a core-pulling hole; further, a plug is formed by a plug die for densely sealing the core-pulling hole. In step 2, the plug and a sealing ring are installed in the core-pulling hole of the body so as to form an insert for an over molding. In step 3, the insert is placed into a die for the over molding so as to be wrapped in a covering, thereby facilitating the plug being set correlative to the body. An integral faucet core assembly is achieved after the drawing of the die. The present invention allows a firm structure of the body of the faucet canal core to be achieved, which contributes to the convenient installation, the facile utilization, the extended using life, and the leakage prevention.

### BACKGROUND OF THE INVENTION

1. Field of the Invention

The present invention relates to a method for making a faucet, in particular to a method for forming an integral faucet core assembly.

2. Description of the Related Art

Nowadays, a household faucet is mainly connected to a cold water pipe and a hot water pipe. Wherein, the hot water and the cold water are combined in the faucet so as to coherently come out of the faucet with a proper temperature. Actually, a body of a faucet canal core is constructed by two vertical pipes communicating with one horizontal pipe, and a middle of the horizontal pipe adopts a combined outlet for properly cooperating with a regulating valve.

The traditional method for making the faucet generally adopts the metal copper to integrally cast a certain passage therein. In view of the high strength featured by the copper, a stable installation could be facilely achieved. However, the price of copper is continuingly increased in the recent years in view of the lack of the source. As a result, the cost for making the body of the faucet canal core is adversely even higher. In addition, the body of the faucet canal core is formed by three parts, a branch type. It is actually difficult to integrally form such faucet of the branch type if a one-time molding is about to be adopted. In order to conquer afore difficulty, the faucet of the branch type is usually disconnected for proceeding to a welding process, or the faucet pipe is separated and then processed by welding. Nonetheless, the faucet that is originally disconnected but welded later has at least two shortcomings. Firstly, the two vertical pipes have to be parallelly settled in a plane. Concurrently, the two vertical pipes have to be arranged inclined with respect to outlets on the horizontal pipe along a certain angle. Obviously, such forming method is complicated while a second process is about to be proceeded. Secondly, joints of the welded pipe concentrically bear pressure. For example, while installing the faucet to a washing platen, a wrenching torque is generated between the vertical pipes and the horizontal pipe while a force is imparted by a tool on the faucet. Or in time of using, an operating force imparted on the faucet also results in the wrenching torque between the vertical pipes and the horizontal pipe. Afore wrenching torque readily causes a breakage on the welding joints of the body of the faucet canal core. As a result, the using life of the faucet is adversely influenced by the broken parts.

In order to avoid the welding process, an over molding is adopted for forming the faucet canal core. A branch insert is prepared for the over molding. Referring to FIGS. 1 and 2, the branch insert 100 is adopted for forming an inner core body 200 via the over molding. Wherein, several extended fins 300 are disposed for fixing the branch insert 100 on the die for over molding in time of manufacturing.

Such over molding favorably solves the problems of the brittle faucet and the short using life occurred in the conventional welding. However, this faucet is actually not integrally formed. That is, the fixing means for the insert adopts the extended fins formed on the die for over molding. Nevertheless, if the combining force of a combining surface between any two parts is not unsatisfactory, a leakage would be adversely resulted from the fins that are exposed to exterior. As a result, the leaking faucet can not satisfy the requirement in life, and the bad faucet is no longer serviceable.

Accordingly, a method for forming an integral faucet core assembly is provided for amending afore problems.

### SUMMARY OF THE INVENTION

The object of the present invention is to provide a method for forming an integral faucet core assembly that contributes to a firm structure, a facile installation, a convenient using, a long using life, and a sealing effect.

Afore object is achieved by means as follows:

The forming method in accordance with the present invention comprises steps of:

step 1: utilizing a die for one-time molding that includes two inlet cores, at least one outlet core, and at least one middle fluid channel core for one-time molding; a body having two inlet channels, at least one outlet channel, and at least one middle fluid channel so as to construct an integral faucet canal via the two inlet channels, the at least one middle fluid channel, and the at least one outlet channel of the body intercommunicated with each other after drawings of the die and the cores; the middle fluid channel and the two inlet channels being arranged perpendicular to each other; an inlet being formed at an exterior of the inlet channel, an outlet being formed at an exterior of the outlet channel, and a core-pulling hole being formed at an exterior of the middle fluid channel after each of the cores being taken out; using a plug die for molding a plug capable of densely sealing the core-puling hole;

step 2: installing the plug and a sealing ring into the core-pulling hole of the body so as to construct an insert for an over molding; and

step 3: placing the insert into a die for over molding; wrapping the insert in a covering that is capable of keeping the plug located in correspondence with said body, so that the integral faucet canal core is formed after drawing said die for over molding.

Preferably, in the step 1, the die for one-time molding directly molds a plurality of fins on a surface of the body, thereby facilitating an over molding process.

Preferably, in the step 1, a sealing slot is directly molded on a surface of the plug by means of the plug die so as to receive the sealing ring.

Preferably, the body processed by the one-time molding, the plug, and the covering processed by the over molding adopt strengthened plastic that contains fiberglass.

A method for forming an integral faucet core assembly, which is especially applied to the integral faucet core assembly in a double handle type, comprises steps of:

step 1: utilizing a die for one-time molding that includes two inlet cores, at least one outlet core, at least one middle fluid channel core, and two valve cores axially aligned with the inlet cores and disposed opposite thereto; a body having two inlet channels, at least one outlet channel, and at least one middle fluid channel so as to construct an integral faucet canal via the two inlet channels, the at least one middle fluid channel, and the at least one outlet channel of the body intercommunicated with each other after drawings of the die and the cores; forming two valve holes, which function to receive the valve cores, being axially formed at a direction opposite to the inlet channels of the body to intercommunicate with the inlet channel and the middle fluid channel and concurrently to receive the valve core; the middle fluid channel and the two inlet channels being arranged perpendicular to each other; an inlet being formed at an exterior of the inlet channel, an outlet being formed at an exterior of the outlet channel, and a core-pulling hole being formed at an exterior of the middle fluid channel after each of the cores being taken out; using a plug die for molding a plug capable of densely sealing the core-puling hole;

step 2: installing the plug and a sealing ring into the core-pulling hole of the body so as to construct an insert for an over molding; and

step 3: placing the insert into a die for over molding; wrapping the insert in a covering that is capable of keeping the plug located in correspondence with the body, so that the integral faucet canal core in the double handle type is formed after drawing the die for over molding.

Preferably, in the step 1, a certain angle is included by a face axially defined between an axial direction of the outlet core and an axis of the inlet cores.

Preferably, the method is especially applied to the integral faucet core assembly having double handles and a spray gun; in the step 1, the spray gun core is axially aligned with the outlet core and disposed opposite thereto; said body axially disposed opposite to said outlet cores is further integrally connected to said spray gun channel of said middle fluid channel, thereby attaining the integral faucet canal core in the double handle type with the spray gun.

A method for forming an integral faucet core assembly, which is especially applied to the integral faucet core assembly in a single handle type, comprises steps of:

step 1: utilizing a die for one-time molding that includes two inlet cores, two outlet cores, and two middle fluid channel cores; a body having two inlet channels, two outlet channels, and two middle fluid channels so as to construct twin integral faucet canals by respectively connecting the inlet channels to the middle fluid channels and the outlet channels of the body after drawings of the die and the cores; the middle fluid channels and the two inlet channels being arranged perpendicular to each other; an inlet being formed at an exterior of the inlet channel, an outlet being formed at an exterior of the outlet channel, and a core-pulling hole being formed at an exterior of the middle fluid channel after each of the cores being taken out; using a plug die for molding a plug capable of densely sealing the core-puling hole;

step 2: installing the plug and a sealing ring into the core-pulling hole of the body so as to construct an insert for an over molding; and

step 3: placing the insert into a die for over molding; wrapping the insert in a covering that is capable of located in correspondence with the body, so that the integral faucet canal core of the single handle type is formed after drawing the die for over molding.

Preferably, in the step 1, an installing core is further included in the die for one-time molding; thereby, an installing hole (like a screw opening) on the body functions as a fixed installation after the die and the cores are taken out.

The faucet canal core is integrally formed. Conquering the leakage resulted from the conventional branch insert and the channels formed by the over molding, the present invention contributes to a firm structure, a facile installation, a convenient using, a long using life, and a sealing effect.

Wherein, the faucet canal of the body is formed by the one-time molding and further wrapped in the covering that is formed by the over molding. Preferably, the covering that is formed by the over molding also envelopes the sealing plug on the core-pulling hole of the integral faucet canal. Thereby, the present invention improves the strength as well as enhances the leakage prevention of the structure.

### BRIEF DESCRIPTION OF THE DRAWINGS

FIG. 1 is a schematic view showing a branch insert in the conventional technique;

FIG. 2 is a perspective view showing the conventional technique;

FIG. 3 is a flowchart showing the present invention;

FIG. 4 is a schematic view showing a body of the faucet canal of a double handle type;

FIG. 5 is a schematic view showing the body of the faucet canal of a double handle type in time of drawing cores;

FIG. 6 is a schematic view showing the body of the faucet canal of a double handle type that an arrangement of cavities in the body is shown;

FIG. 7 is a schematic view showing the body, a plug, and a covering of the faucet canal of a double handle type;

FIG. 7-1 is a schematic view showing a faucet canal core of a double handle type;

FIG. 7-2 is a cross-sectional view showing the body of the faucet canal of a double handle type;

FIG. 8 is a schematic view showing the body of the faucet canal of a double handle type with a lower die as well as the core that are proceeded to the one-time molding;

FIG. 9 is a schematic view showing the body of the faucet canal of a double handle type with an upper die that is proceeded to the one-time molding;

FIG. 10 is a schematic view showing the body of the faucet canal of a double handle type that the dies are proceeded to close;

FIG. 11 is a schematic view showing the body of the faucet canal of a double handle type with the core that is proceeded to the one-time molding;

FIG. 12 is a schematic view showing the body of the faucet canal of a double handle type with the core of the outlet channel that is proceeded to the one-time molding;

FIG. 13 is a schematic view showing the body of the faucet canal of a double handle type with the middle fluid channel core that is proceeded to the one-time molding;

FIG. 14 is a schematic view showing the body of the faucet canal of a double handle type with the upper die and the lower die that are proceeded to the over molding;

FIG. 15 is a schematic view showing the body, the plug, and the covering of the faucet canal of a double handle type;

FIG. 15-1 is a schematic view showing the body of the faucet canal having double handles and a spray gun core;

FIG. 15-2 is a cross-sectional view showing the body of the faucet canal having double handles and a spray gun;

FIG. 16 is a schematic view showing the body of the faucet canal of a double handle type with the upper die and the core that are proceeded to the one-time molding;

FIG. 17 is a schematic view showing the body of the faucet canal of a double handle type with the lower die that is proceeded to the one-time molding;

FIG. 18 is a schematic view showing the body of the faucet canal of a double handle type with the dies that are proceeded to close;

FIG. 19 is a schematic view showing the body of the faucet canal of a double handle type with the cores that are about to be drawn;

FIG. 20 is a schematic view showing the body of the faucet canal of a double handle type with the upper die and the lower die that are proceeded to the over molding;

FIG. 21 is a schematic view showing the body, the plug, and the covering of the faucet canal of a single handle type;

FIG. 21-1 is a schematic view showing a faucet canal core of a single handle type;

FIG. 21-2 is a cross-sectional view showing the body of the faucet canal of a single handle type;

FIG. 22 is a schematic view showing the body of the faucet canal of a single handle type with an upper die as well as the core that are proceeded to the one-time molding;

FIG. 23 is a schematic view showing the body of the faucet canal of a single handle type with a lower die that is proceeded to the one-time molding;

FIG. 24 is a schematic view showing the body of the faucet canal of a single handle type that the dies are proceeded to close;

FIG. 25 is a schematic view showing the body of the faucet canal of a single handle type with the core that is proceeded to the one-time molding; and

FIG. 26 is a schematic view showing the body of the faucet canal of a double handle type with the upper die and the lower die that are proceeded to the over molding.

### DETAILED DESCRIPTION OF THE PREFERRED EMBODIMENTS

Following embodiments along with the drawings preferably show the present invention clearly.

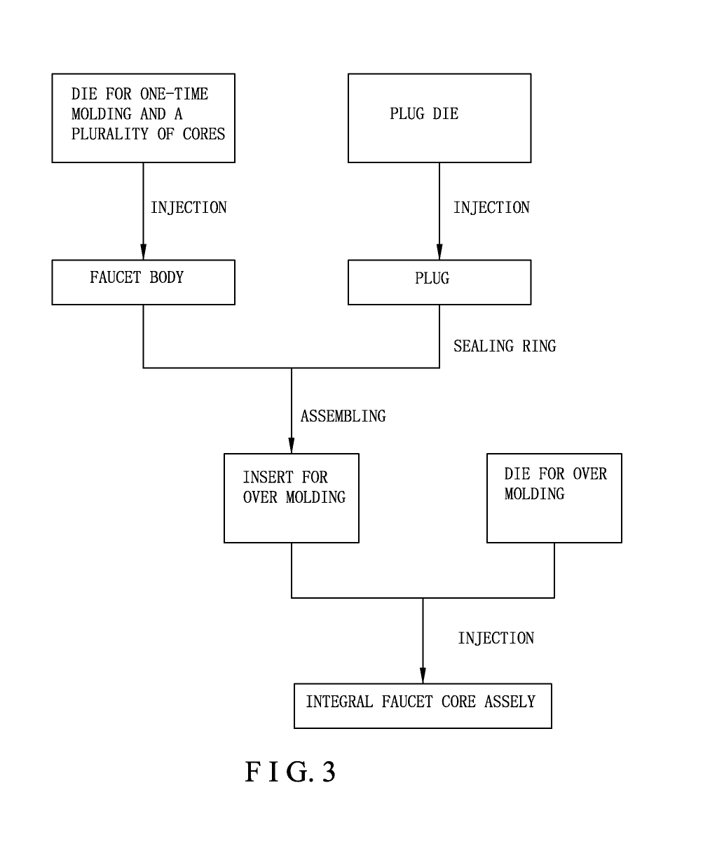

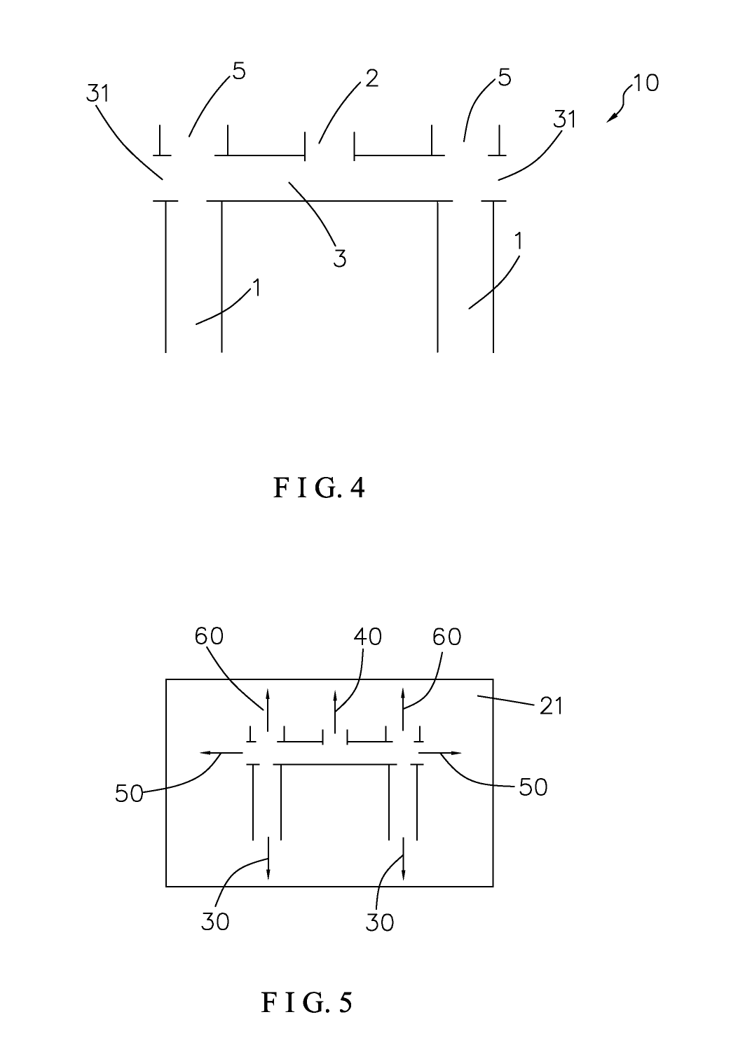

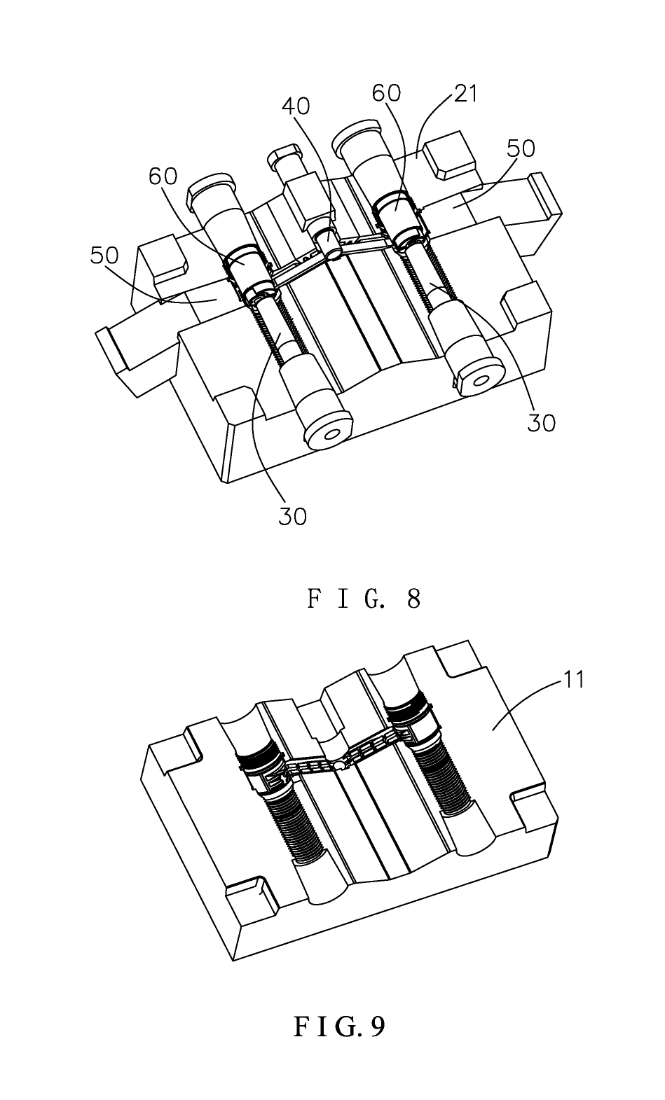

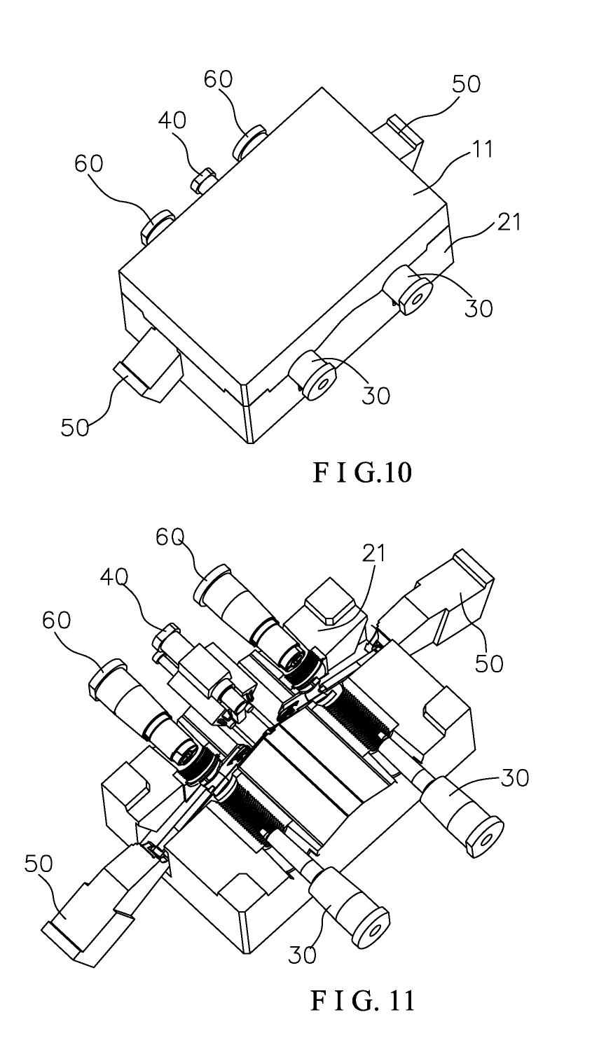

Referring to FIGS. 3 to 14, a method for forming an integral faucet core assembly, which is especially applied to the integral faucet core assembly in a double handle type, comprises steps of:

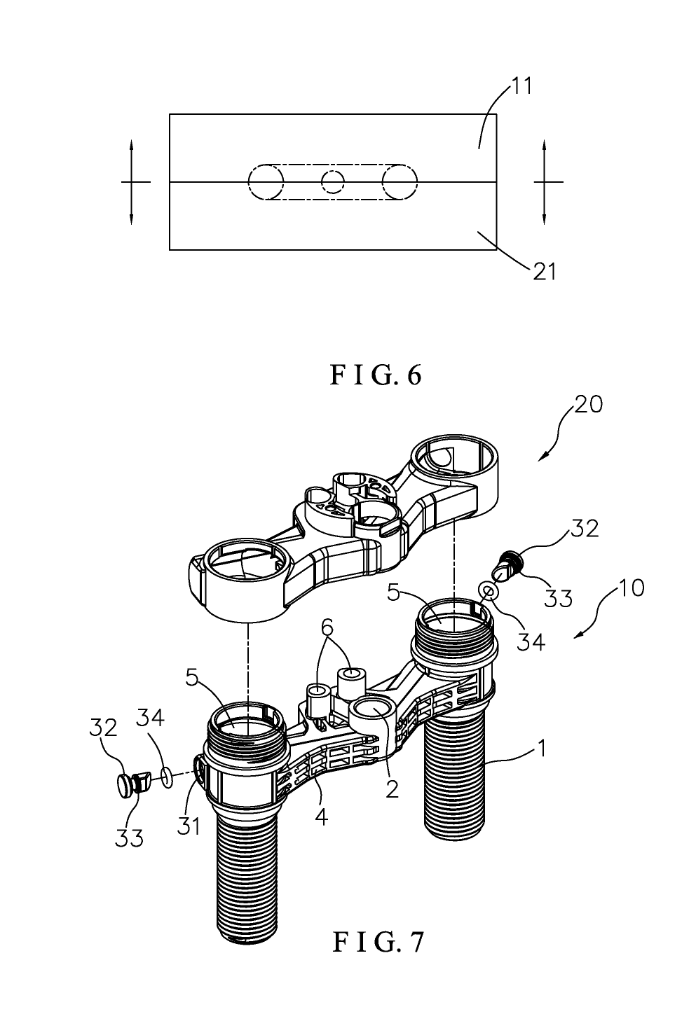

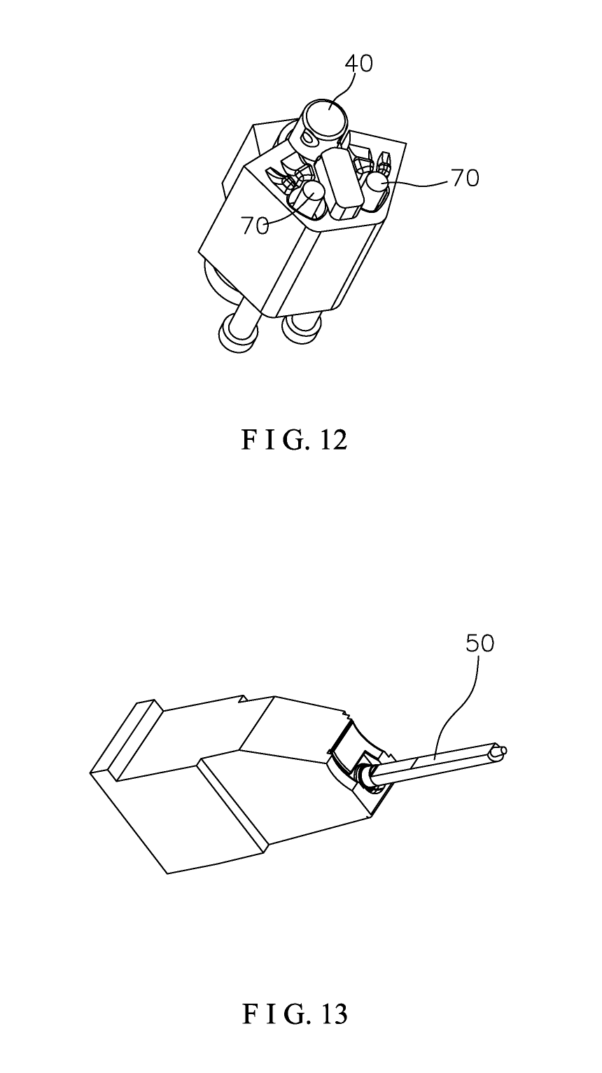

Step 1: utilize a die for one-time molding (as an upper mold 11 and a lower mold 21 are provided in FIGS. 6, 8, and 10) that includes two inlet cores 30 (as shown in FIGS. 5, 8, 10, and 11), one outlet core 40 (as shown in FIGS. 5, 8, 10, 11, and 12; in this embodiment, a certain angle is included by a face axially defined between an axial direction of the outlet core 40 and an axis of the inlet cores 30.), two middle fluid channel core 50 (as shown in FIGS. 5, 8, 10, 11, and 13), two valve cores 60 (as shown in FIGS. 5, 8, 10, and 11), and a plurality of installing cores 70 (as shown in FIG. 12) convergently disposed on the outlet core 40; form a body 10 (as shown in FIGS. 4, 7, and 7-2) via two inlet channels 1 (including a hot inlet pipe and a cold inlet pipe), one outlet channel 2, one middle fluid channel 3, and two valve holes 5 (including a hot valve hole and a cold valve hole) through the one-time molding; an installing hole 6 (like a screw hole) is constructed on a surface of the body 10 for installation; construct an integral faucet canal via the two inlet channels 1, the two valve holes 5, one middle fluid channel 3, and the two outlet channel 2 of the body 10 intercommunicated with each other after drawings of the die and the cores; the middle fluid channel 3 and the two inlet channels 1 are arranged perpendicular to each other; the inlet channels 1 are formed on the axis same as that of valve holes 5 along a direction opposite to the same; an inlet is formed at an exterior of the inlet channel 1, an outlet is formed at an exterior of the outlet channel 2, and a core-pulling hole 31 is formed at an exterior of the middle fluid channel 3 after each of the cores are taken out; the die for one-time molding directly molds a plurality of fins 4 on a surface of the body 10, thereby facilitating an over molding process, so that a covering 20 of the over molding could be appropriately combined with the body 10.

Further, a plug 32 is formed via a plug die for densely sealing the core-puling hole 31. A sealing slot 33 is directly molded on a surface of the plug 32 by means of the plug die so as to receive a sealing ring 34, so that a better sealing effect could be achieved.

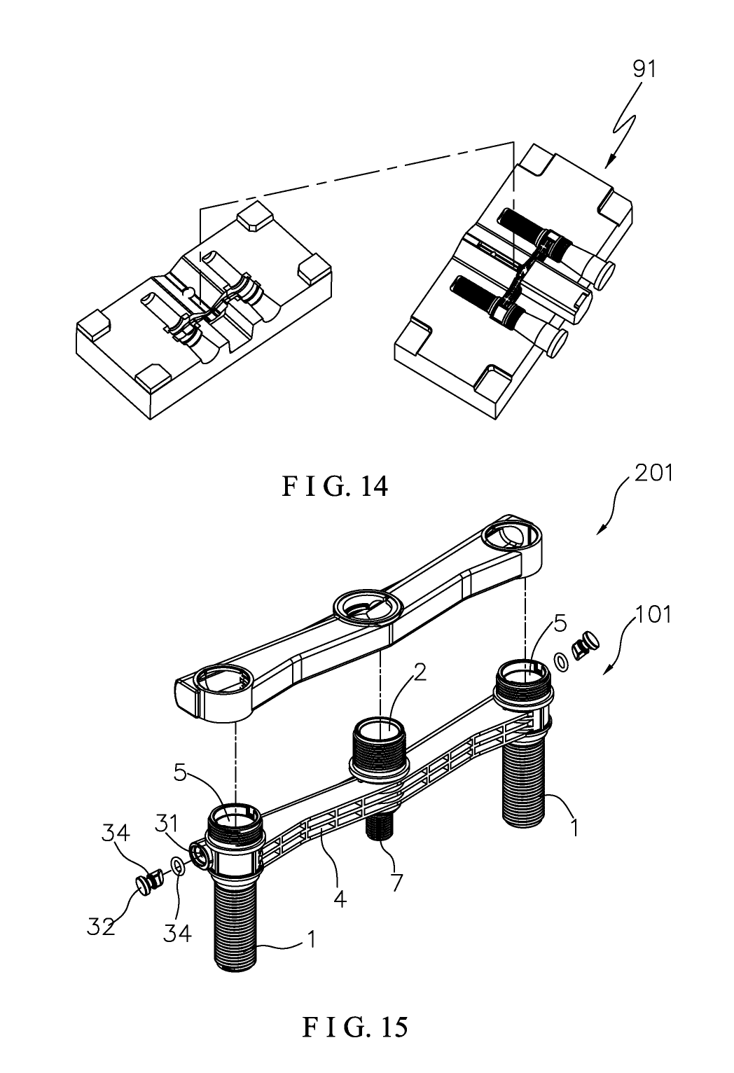

Step 2: install the plug 32 and the sealing ring 34 into the core-pulling hole 31 of the body 10 so as to construct an insert for the over molding as shown in FIG. 14.

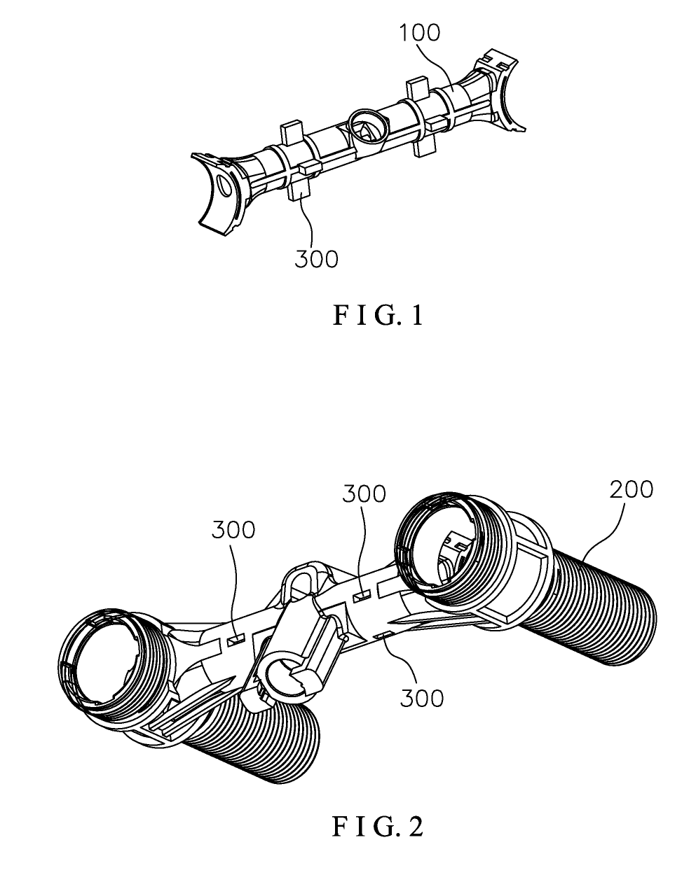

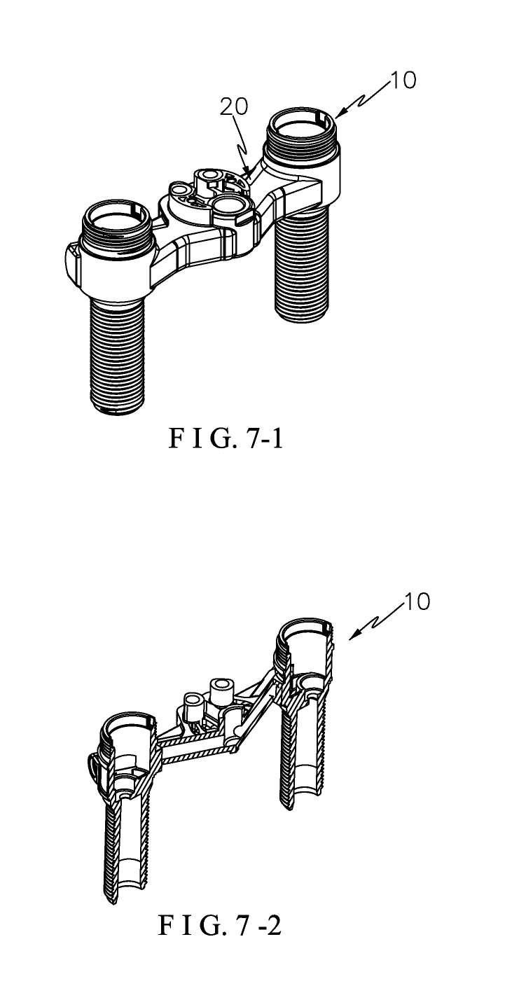

Step 3: referring to FIGS. 14 and 7, place the insert into a die 91 for the over molding; wrap the insert in the covering 20 that is capable of keeping the plug 32 located in correspondence with the body 10, so that the integral faucet canal core in the double handle type is formed after drawing the die for over molding as shown in FIG. 7-1.

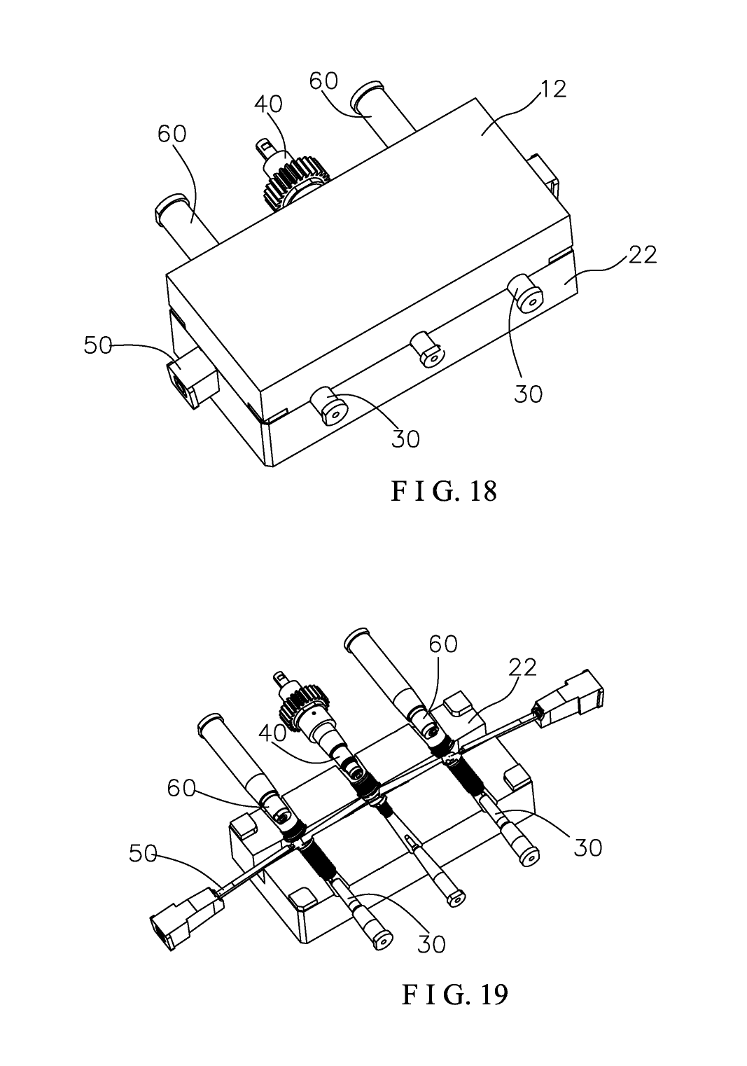

Referring to FIGS. 3, and 15 to 20, the method of the present invention is especially applied to the integral faucet core assembly having double handles and a spray gun; following steps are concerned:

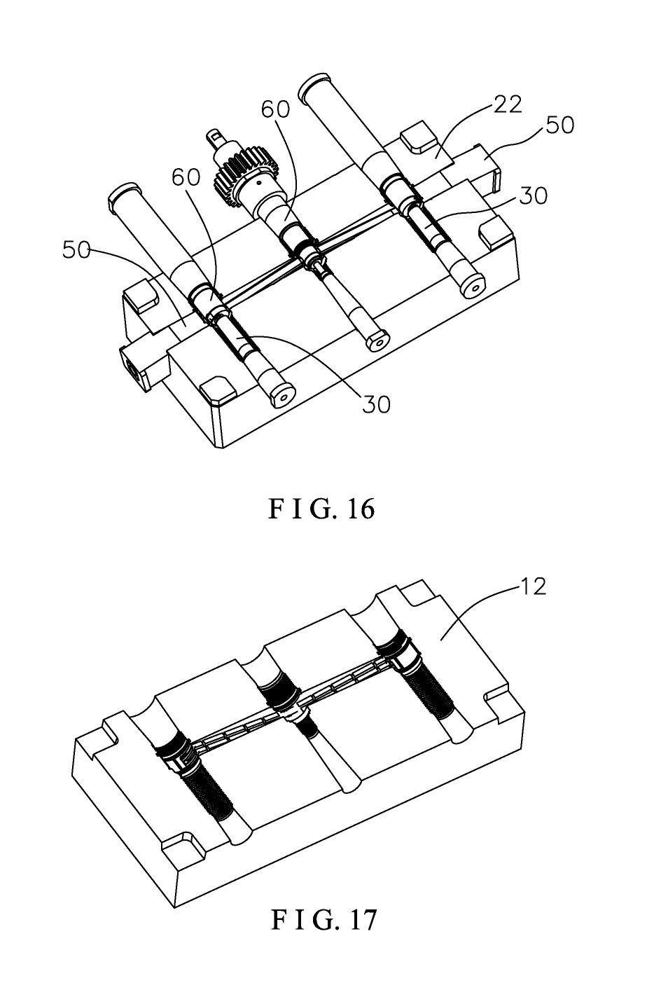

Step 1: referring to FIGS. 16 to 19, utilize a die for one-time molding (as an upper mold 12 and a lower mold 22 are provided) that includes two inlet cores 30, one outlet core 40 (like a thread mechanism), two middle fluid channel core 50, two valve cores 60, and a spray gun core 80; form a body 101 via two inlet channels 1 (including a hot inlet pipe and a cold inlet pipe), one outlet channel 2, one middle fluid channel 3, two valve holes 5 (including a hot valve hole and a cold valve hole) through the one-time molding, and one spray gun channel 7; construct an integral faucet canal via the two inlet channels 1, the two valve holes 5, one middle fluid channel 3, the two outlet channel 2, and the spray gun core 7 of the body 101 intercommunicated with each other after drawings of the die and the cores; the middle fluid channel 3 and the two inlet channels 1 are arranged perpendicular to each other; the inlet channels 1 are formed on the axis same as that of valve holes 5 along a direction opposite to the same; the outlet channel 2 is formed on the axis same as that of spray gun channel 7 along a direction opposite to the same; an inlet is formed at an exterior of the inlet channel 1, an outlet is formed at an exterior of the outlet channel 2, and a core-pulling hole 31 is formed at an exterior of the middle fluid channel 3 after each of the cores are taken out; in the step 1, the die for one-time molding directly molds a plurality of fins 4 on a surface of the body 101, thereby facilitating an over molding process, so that a covering 201 of the over molding could be appropriately combined with the body 101.

Further, the plug 32 is formed via a plug die for densely sealing the core-puling hole 31. The sealing slot 33 is directly defined on a surface of the plug 32 by means of the die so as to receive a sealing ring 34, so that a better sealing effect could be achieved.

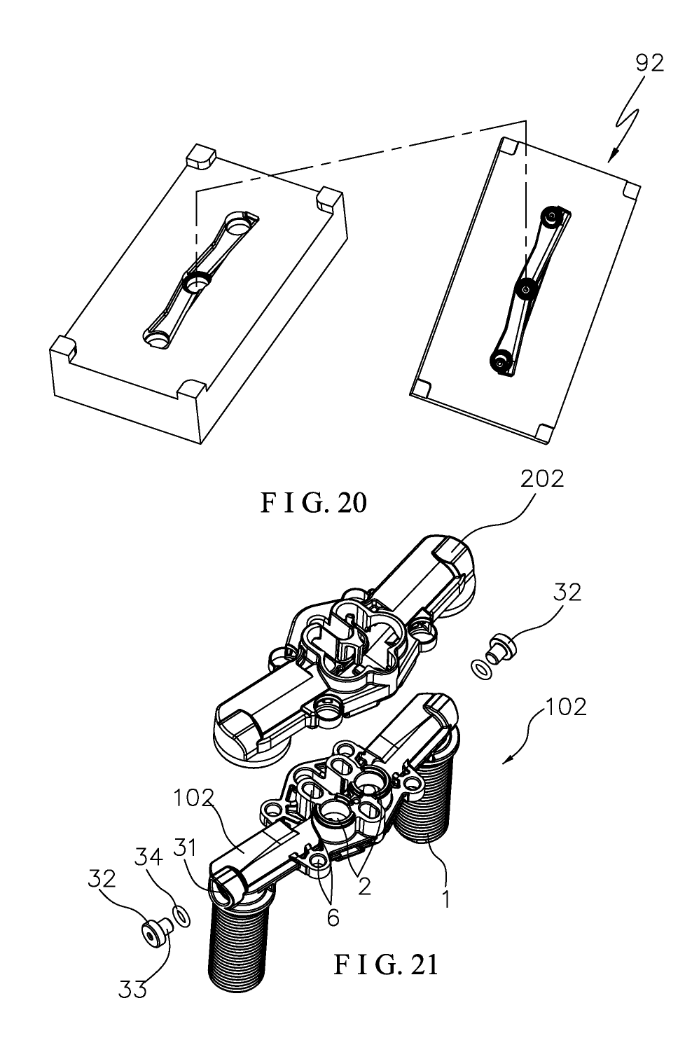

Step 2: install the plug 32 and the sealing ring 34 into the core-pulling hole 31 of the body 101 so as to construct an insert for the over molding as shown in FIG. 20.

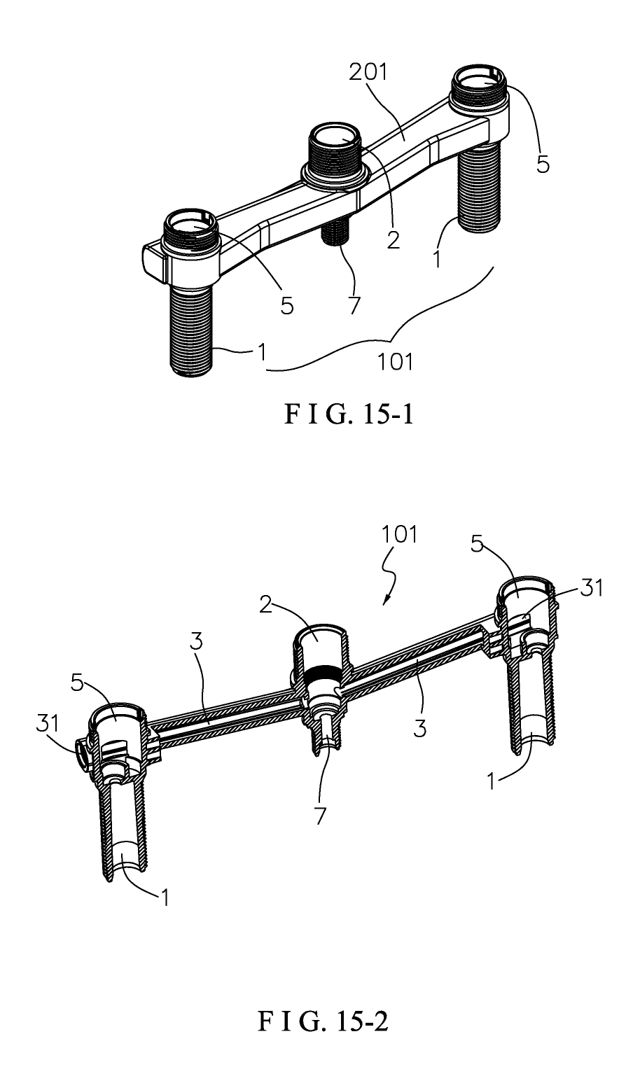

Step 3: referring to FIGS. 20 and 15, place the insert into a die 92 for the over molding; wrap the insert in the covering 201 that is capable of keeping the plug 32 located in correspondence with the body 101, so that the integral faucet canal core in the double handle type with the spray gun is formed after drawing the die for over molding as shown in FIG. 15-1.

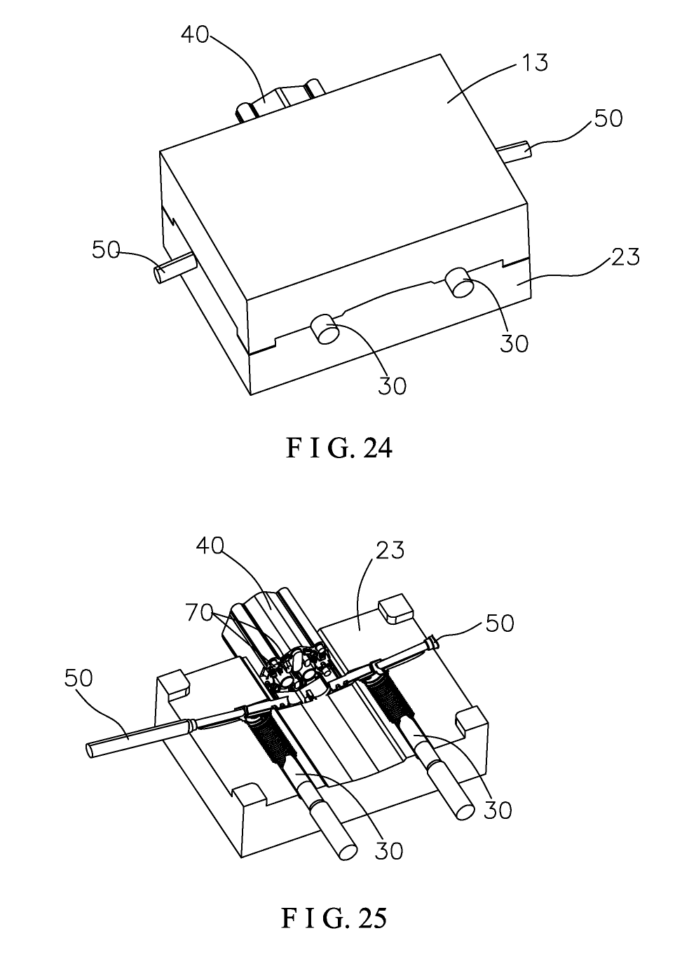

Referring to FIGS. 3, and 21 to 26, a method for forming an integral faucet core assembly, which is especially applied to the integral faucet core assembly in a single handle type, comprising steps of:

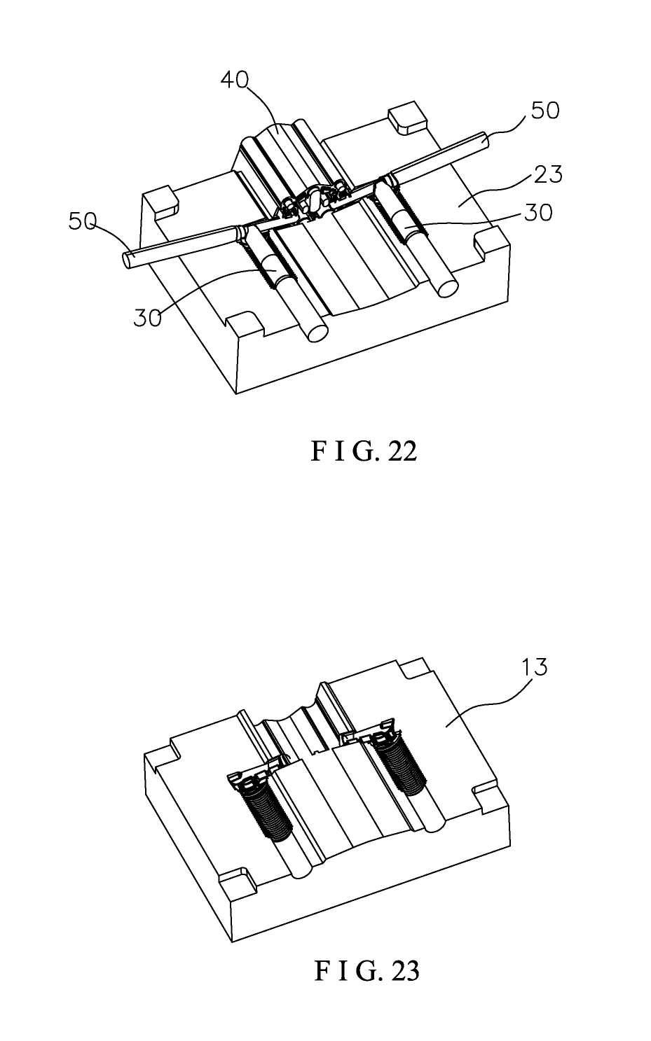

Step 1: referring to FIG. 22 to 25, utilize a die for one-time molding (as an upper mold 13 and a lower mold 23 are provided) that includes two inlet cores 30, one outlet core 40, two middle fluid channel core 50, and a plurality of installing cores 70 (as shown in FIGS. 22 and 25) convergently disposed on the outlet core 40; form a body 102 via two inlet channels 1 (including a hot inlet pipe and a cold inlet pipe), one outlet channel 2 and one middle fluid channel 3; an installing hole 6 (like a screw hole) is constructed on a surface of the body 102 for installation; construct an integral twin faucet canals via the two inlet channels 1, one middle fluid channel 3, and the two outlet channel 2 of the body 102 intercommunicated with each other after drawings of the die and the cores; the middle fluid channel 3 and the two inlet channels 1 are arranged perpendicular to each other; an inlet is formed at an exterior of the inlet channel 1, an outlet is formed at an exterior of the outlet channel 2, and a core-pulling hole 31 is formed at an exterior of the middle fluid channel 3 after each of the cores are taken out; in the step 1, the die for one-time molding directly molds a plurality of fins 4 on a surface of the body 102, thereby facilitating an over molding process, so that a covering 202 of the over molding could be appropriately combined with the body 102.

Further, the plug 32 is formed via a plug die for densely sealing the core-puling hole 31. The sealing slot 33 is directly defined on a surface of the plug 32 by means of the die so as to receive the sealing ring 34, so that a better sealing effect could be achieved.

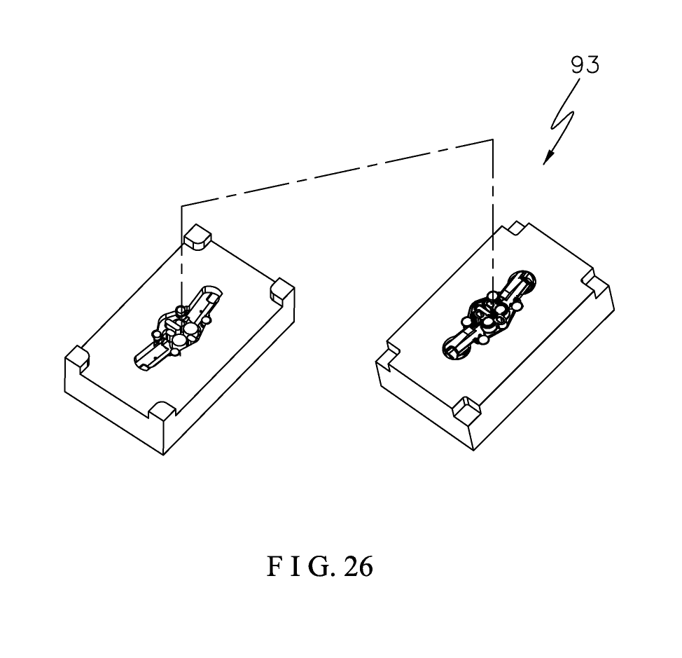

Step 2: install the plug 32 and the sealing ring 34 into the core-pulling hole 31 of the body 10 so as to construct an insert for the over molding as shown in FIG. 26.

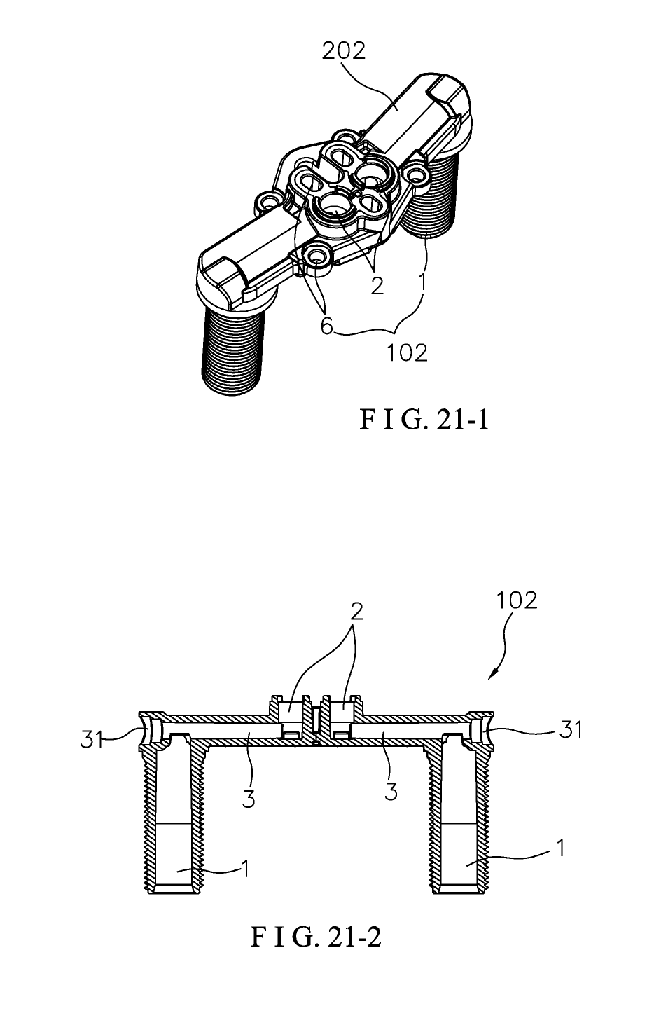

Step 3: referring to FIGS. 26 and 21, place the insert into a die 93 for the over molding; wrap the insert in the covering 202 that is capable of keeping the plug 32 located in correspondence with the body 102, so that the integral faucet canal core in the single handle type is formed after drawing the die for over molding as shown in FIG. 21-1.

Favorably, the body 10 processed by the one-time molding, the plug 32, and the covering 20 processed by the over molding adopt strengthened plastic that contains fiberglass.

Above embodiments do not limit the spirit of the present invention. The types and the numbers of the dies, the cores, and the molding materials are not limited. Alike allusion, deduction, or any similar replacement does not depart from the scope of the present invention.

I claim:

1. A method for forming an integral faucet core assembly comprising steps of:
step 1: utilizing a die for one-time molding that includes two inlet cores, at least one outlet core, and at least one middle fluid channel core; a body having two inlet channels, at least one outlet channel, and at least one middle fluid channel so as to construct an integral faucet canal via said two inlet channels, said at least one middle fluid channel, and said at least one outlet channel of said body intercommunicated with each other after drawings of said die and said cores; said middle fluid channel and said two inlet channels being arranged perpendicular to each other; an inlet being formed at an exterior of said inlet channel, an outlet being formed at an exterior of said outlet channel, and a core-pulling hole being formed at an exterior of said middle fluid channel after each of said cores being taken out; using a plug die for molding a plug capable of densely sealing said core-puling hole;
step 2: installing said plug and a sealing ring into said core-pulling hole of said body so as to construct an insert for an over molding; and
step 3: placing said insert into a die for over molding; wrapping said insert in a covering that is capable of keeping said plug located in correspondence with said body, so that the integral faucet canal core is formed after drawing said die for over molding.

2. The method as claimed in claim 1, wherein, in said step 1, said die for one-time molding directly molds a plurality of fins on a surface of said body, thereby facilitating an over molding process.

3. The method as claimed in claim 1, wherein, in said step 1, a sealing slot is directly molded on a surface of said plug by means of said plug die so as to receive said sealing ring.

4. The method as claimed in claim 1, wherein, said body processed by said one-time molding, said plug, and said covering processed by said over molding adopt strengthened plastic that contains fiberglass.

5. A method for forming an integral faucet core assembly, which is especially applied to said integral faucet core assembly in a double handle type, comprising steps of:
step 1: utilizing a die for one-time molding that includes two inlet cores, at least one outlet core, at least one middle fluid channel core, and two valve cores axially aligned with said inlet cores and disposed opposite thereto; a body having two inlet channels, at least one outlet channel, and at least one middle fluid channel so as to construct an integral faucet canal via said two inlet channels, said at least one middle fluid channel, and said at least one outlet channel of said body intercommunicated with each other after drawings of said die and said cores; two valve holes, which function to receive said valve cores, being axially formed at a direction opposite to said inlet channels of said body to intercommunicate with said inlet channels and said middle fluid channel; said middle fluid channel and said two inlet channels being arranged perpendicular to each other; an inlet being formed at an exterior of said inlet channel, an outlet being formed at an exterior of said outlet channel, and a core-pulling hole being formed at an exterior of said middle fluid channel after each of said cores being taken out; using a plug die for molding a plug capable of densely sealing said core-puling hole;
step 2: installing said plug and a sealing ring into said core-pulling hole of said body so as to construct an insert for an over molding; and
step 3: placing said insert into a die for over molding; wrapping said insert in a covering that is capable of keeping said plug located in correspondence with said body, so that said integral faucet canal core in a double handle type being formed after drawing the die for over molding.

6. The method as claimed in claim 5, wherein, in said step 1, a certain angle is included by a face axially defined between an axial direction of said outlet core and an axis of said inlet cores.

7. The method as claimed in claim 5, wherein, said method is especially applied to said integral faucet core assembly having double handles and a spray gun; in said step 1, the spray gun core is axially aligned with said outlet core and disposed opposite thereto; said body axially disposed opposite to said outlet cores is further integrally connected to said spray gun channel of said middle fluid channel, thereby attaining said integral faucet canal core of said double handle type with said spray gun.

8. A method for forming an integral faucet core assembly, which is especially applied to said integral faucet core assembly in a single handle type, comprising steps of:
step 1: utilizing a die for one-time molding that includes two inlet cores, two outlet cores, and two middle fluid channel cores; a body having two inlet channels, two outlet channels, and two middle fluid channels so as to form twin faucet canals by respectively connecting said inlet channels to said middle fluid channels and said outlet channels of said body after drawings of said die and said cores; said middle fluid channels and said two inlet channels being arranged perpendicular to each other; an inlet being formed at an exterior of said inlet channel, an outlet being formed at an exterior of said outlet channel, and a core-pulling hole being formed at an exterior of said middle fluid channel after each of said cores being taken out; using a plug die for molding a plug capable of densely sealing said core-puling hole;
step 2: installing said plug and a sealing ring into said core-pulling hole of said body so as to construct an insert for an over molding; and
step 3: placing said insert into a die for over molding; wrapping said insert in a covering that is capable of keeping said plug located in correspondence with said body, so that the integral faucet canal core in said single handle type is formed after drawing said die for over molding.

9. The method as claimed in claim 8, wherein, in said step 1, an installing core is further included in said die for one-time molding; thereby, an installing hole on said body functioning as a fixed installation after said die and said cores are taken out.
